(19) United States
(12) Patent Application Publication
(10) Pub. No.: US 2008/0248958 A1
(43) Pub. Date: Oct. 9, 2008

(54) System for pulling out regulatory elements in vitro

(76) Inventor: Andrew D. Hollenbach, (US)

Correspondence Address: ADAMS AND REESE LLP, 4400 ONE HOUSTON CENTER, 1221 MCKINNEY, HOUSTON, TX, 77010, US

(21) Appl. No.: 11/697,154

(22) Filed: Apr. 5, 2007

(51) Int. Cl. C40B 20/04; C40B 20/00

(52) U.S. Cl. 506/4; 506/2

(57) ABSTRACT

Disclosed are methods for identifying molecular interactions between proteins and DNA sequences in vitro. All of the methods of the invention employ known or suspected DNA-binding proteins and genomic DNA from a stable library. Interacting molecules direct the expression of a reporter gene, the expression of which is then assayed. Also disclosed are genetic constructs useful in practicing the methods of the invention.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

The Sequence Listing, which is a part of the present disclosure and is submitted in conformity with 37 CFR §§1.821-1.825, includes a computer readable form and a written sequence listing comprising nucleotide and/or amino acid sequences of the present invention. The sequence listing information recorded in computer readable form (created 26 Mar. 2006; filename: Sequence_Listing_In_vitro_PORE_ST25; size: 10.8 KB) is identical to the written sequence listing. The subject matter of the Sequence Listing is incorporated herein by reference in its entirety.

### BACKGROUND OF THE INVENTION

1. Field of the Invention

The present invention is drawn to in vitro methods of measuring and testing for interactions between proteins and nucleic acids, and relates to an improved method for the in vitro identification and optional characterization of genomic DNA sequences that interact with DNA-binding proteins.

2. Description of Related Art

Numerous biologically important functions involve transient interactions between DNA molecules and proteins, RNA molecules and proteins, two or more proteins or RNA molecules, or ligands and receptors. Recognition and binding of sequence-specific DNA-binding proteins to regulatory elements within the genome are critical steps in the spatio-temporal control of gene expression. These steps ensure proper replication and cell division, and direct epigenetic controls important for proper cellular function in all organisms.

For example, the transcription factor PAX3 (paired box gene 3; HUP2) is a DNA binding protein that is expressed during early neurogenesis and which regulates expression of MITF (microphthalmia-associated transcription factor). The term “transcription factor” describes any protein required to initiate or regulate DNA transcription in eukaryotes. Mutations in PAX3 are implicated in Waardenburg syndrome types I and III (WS1 and WS3), and PAX3 proteins associated with WS1 fail to recognize or transactivate the MITF promoter. PAX3 binds to a proximal region of the MITF promoter, but mutations to PAX3 prevent its activating the promoter and lead to impaired Mitf expression.

Many genes of higher eukaryotes are transcribed into mRNA only in specific cell-types. For example, reticulocytes (immature red blood cells) contain mRNA for hemoglobin—the iron-containing oxygen-transport metalloprotein in red blood cells—while nerve cells do not. The particular DNA sequences that encode the mRNA in a cell can be cloned by using retroviral reverse transcriptase to make DNA copies of the mRNA (the copies are called “complimentary DNA,” or cDNA clones) isolated from the cell. These single-stranded cDNA clones are converted into double-stranded DNAs and cloned into plasmid vectors, creating a cDNA library for that particular cell-type. cDNA libraries contain only sequences expressed as mRNA in the particular cell-type used to generate the library, but they lack the intronic (intragenic), non-coding sequences of genomic DNA, which were spliced out of the transcribed RNA sequences by posttranscriptional modification. cDNA libraries also contain 5′ and 3′ untranslated regions (5′-UTR and 3′-UTR), which are non-coding nucleotide regions at either end of each mRNA molecule, and derive from DNA adjacent to the gene. The 5′- and 3′-UTRs may contain protein binding sites, and can be involved in regulating expression of the adjacent gene.

In many eukaryotes, a large percentage of the total genome is comprised of non-coding DNA that does not lie near any gene. It is also clear, however, that gene transcription is often stimulated by DNA regions called “enhancers,” which contain protein binding sites and may be located in non-coding regions tens of thousands of base pairs upstream or downstream from the transcriptional start site. Many mammalian genes are regulated by more than one enhancer region, and their identification and characterization represents a difficult problem. While a cDNA library can help identify the chromosomal location of a gene, it cannot reveal the locations of enhancers. A cDNA library is also of limited use in identifying promoter-proximal elements, which are non-coding regions that lie much closer to transcriptional start sites (e.g., 100-200 base pairs upstream) and also provide protein binding sites, but which are not contained within mRNA, and so are not contained in cDNA libraries. Still, the relative proximity of promoter elements makes them easier to find than enhancers. Because enhancer and promoter elements are so fundamental to the regulation of transcription, and because the dysregulation of transcription can lead to disease, methods of identifying and characterizing enhancer and promoter have generated tremendous interest.

Study of DNA outside the immediate vicinity of genes—outside the regions covered by cDNA libraries—necessitates the use of genomic DNA libraries. Genomic DNA is all the DNA sequences comprising the genome (the total genetic information carried) of a cell or organism, and a genomic DNA library is a collection of clones that contains the entire genome. Like cDNA libraries, genomic DNA libraries are often contained within plasmid vectors. However, genomic DNA libraries are derived directly from genomic DNA, not mRNA, and so contain non-coding DNA (including introns) as well as coding DNA (exons). Creating genomic DNA libraries is difficult, however, because of the relatively low efficiency of E. coli transformation and the number of colonies that can be grown on a culture plate. A genomic DNA library must contain a sufficient number of independently-derived clones that the probability is high (≧950%) that every DNA sequence of the organism is contained within the library. The difficulty of creating such libraries is compounded by the effects of some cloned genomic DNA fragments, which may contain promoter or enhancer elements, sequences that encode toxic peptides, or other unstable elements. For example, a clone containing a promoter or enhancer may drive transcription into the plasmid vector, thus interfering with the vector's replication or expression of drug resistance. The resulting library would lack genomic DNA clones bearing those sequences because bacteria bearing those clones would die, yet those are some of the very sequences that are the object of study by the methods of this invention.

Mutation of either a DNA-binding protein or a genomic regulatory element may disrupt their ability to interact, thereby producing dire consequences by altering the biological processes under their control. Such mutations can form the basis of congenital diseases, or of certain cancers. While many DNA-binding proteins and the nucleic acid sequences they recognize have been identified, there remains a need for improved methods to investigate and identify the manner in which they interact, the genomic contexts of these sequences, the downstream genes they in turn control, the biological processes they regulate.

Therefore, identifying the regulatory elements in a genomic DNA context is critical not only for understanding their role in normal biological activities but in determining the underlying molecular mechanisms that contribute to genetic disorders and the diseased state.

The conventional method for identifying genomic regulatory elements that are recognized and bound by specific DNA-binding proteins is chromatin immunoprecipitation (ChIP), and its variants: ChIP paired-end diTag (ChIP-PET) sequencing; and ChIP microarray (ChIP-chip). ChIP (Orlando et al., 1997) is a procedure used to determine whether a known protein binds to or is localized to a specific genomic DNA sequence in vivo (e.g., in mammalian cells). Using formaldehyde (a process known as “fixation”), DNA-binding proteins are crosslinked to DNA in vivo (i.e., host cells are “fixed” with formaldehyde). Chromatin from the cells is isolated, and the DNA is sheared or restriction-digested into small fragments (some of which are also comprised of crosslinked DNA). Crosslinked DNA-binding proteins are immunoprecipitated using protein-specific antibodies, and so co-immunoprecipitating any attached DNA attached to the proteins. The crosslinking is reversed, and polymerase chain reaction (PCR) is used to amplify specific DNA sequences to identify those that were bound to the protein and co-immunoprecipitated with the antibody. Alternatively, the isolated fragments can be cloned into a plasmid vector for subsequent sequence analysis. Either method provides a population of DNA fragments that are able to interact with the particular DNA-binding protein used. ChIP-PET (Wei et al., 2006) is an enhanced ChIP technique whereby two 18 base-pair sequence tags, one from each end of a DNA fragment isolated by ChIP, are extracted and joined together. The joined tags are then sequenced to identify transcription factor binding sites. Finally, ChIP and ChIP-PET techniques may be enhanced further by hybridizing the extracted sequences to a microarray chip (ChIP-chip) (Ren et al., 2000).

While ChIP and its variants can provide valuable information regarding binding sites for DNA-binding proteins-transcription factors in particular—the methods suffer significant limitations. ChIP analysis requires extensive cellular manipulations with multiple steps that must be optimized for each individual DNA-binding protein to be analyzed. ChIP analysis is also dependent on the ability to express the desired DNA-binding protein in a suitable cell type. The major disadvantage of ChIP techniques is the requirement for highly specific antibodies for each protein to be tested. The immunoprecipitation steps of ChIP analysis can be limited severely by the lack of suitable antibodies specific for the DNA-binding protein, and so may require the creation of an epitope-tagged protein (e.g., incorporating an HA or c-Myc moiety at the C- or N-terminus of the DNA-binding protein). In the absence of an antibody specific for the protein tested, any epitope tag added may be masked when the DNA-binding protein is bound to the DNA, severely inhibiting the ability of the epitope-specific antibody to immunoprecipitate the DNA-binding protein. Because ChIP is performed in a cellular context, the analysis is limited to identifying regulatory elements active only in that particular cell type. In the ChIP-chip procedure, analysis is limited to the regions of genomic DNA present on the microarray chips. Finally, ChIP-chip analysis requires the purchase and maintenance of expensive microarray systems, in addition to experienced personnel to assist in analyzing the results.

A variety of in vitro selection methods have been described for identifying nucleic acids that bind target molecules such as proteins, peptides, hormones, antigens, viruses, etc. For example, U.S. Pat. No. 5,270,163 (Gold et al.) describes a method referred to as SELEX (Systematic Evolution of Ligands by Exponential Enrichment) for the identification of nucleic acid ligands. That method is characterized by the following steps: a candidate mixture of single-stranded nucleic acids having regions of randomized sequence is contacted with a target compound. The nucleic acids that have an increased affinity to the target are partitioned from the remainder of the candidate mixture, and the partitioned nucleic acids are then amplified by PCR to yield a ligand-enriched mixture. Repeated cycles of selection, partition, and amplification are repeated until the desired goal is achieved.

Numerous variations of the SELEX method exist. For example, U.S. Pat. No. 6,933,116 (Gold et al.) discloses a method used to isolate nucleic acid ligands that bind to proteins. This facilitates the determination of a protein's binding site on a region of DNA or RNA. That method can also be used to determine whether the nucleic acid ligand inhibits such binding. U.S. Pat. No. 7,153,948 (Gold et al.) applies the SELEX method to isolate high affinity nucleic acid ligands to vascular endothelial growth factor (VEGF) protein. U.S. Pat. No. 7,176,295 (Biesecker et al.) further applies the SELEX method to create nucleic acid ligands with additional functional units to provide specifically selected functionalities, such as a higher affinity for binding a target molecule.

All of the aforementioned methods employ randomly-generated libraries of oligonucleotude fragments to identify a target or a target binding site. The source of the fragments may be from naturally-occurring nucleic acids, chemically synthesized nucleic acids, and/or enzymically synthesized nucleic acids. However, the SELEX method is problematic when the source of oligonucleotude fragments is sheared genomic DNA. This is because the DNA must be ligated with PCR linkers to carry out the amplification step. Such ligation steps are fraught with inefficiency and uncertainty, and impose severe limitations on the SELEX methods.

The present invention is distinguishable from prior art methods in that it uses a stable genomic DNA library housed in a high stability cloning vector. The prior art, in contrast, simply discloses oligonucleotude fragments. The methods of the present invention improve the efficiency and precision by eliminating the need for an additional ligation step with PCR linkers. The present invention can be further distinguished in that the method facilitates the identification and amplification of regulatory elements and direct transcriptional targets, as opposed to simply identifying random nucleic acid sequences that are capable of binding target molecules. Finally, by using a stable genomic DNA library cloned into a plasmid vector, the present invention eliminates the sophisticated and expensive DNA synthesis methods required by the prior art.

The technical problem underlying the present invention was therefore to overcome these prior art difficulties, furnishing a system that reliably yields genomic DNA sequences that interact with DNA-binding proteins, and is suitable for large-scale protein-versus-library screens.

The solution to the technical problem above is provided by the embodiments characterized in the claims.

### BRIEF SUMMARY OF THE INVENTION

The methods described herein provide significant improvements over conventional methods for identifying genomic regulatory elements that are recognized and bound by specific DNA-binding proteins, particularly over the ChIP assay and its variants, enabling one to isolate and to “pull out regulatory elements” (PORE). First, the methods of this invention are designed to use purified protein in vitro to pull out regulatory elements (“In vitro PORE”), thus removing the need for extensive optimization of multiple in vivo steps for each individual protein. Second, because highly defined systems are used with the methods of the present invention, protein expression issues are not a concern and specific antibodies are not required. Third, because entire genomic libraries are being used, the methods of the present invention are not limited to one particular cell or tissue type. Fourth, unlike other in vitro methods, the genomic DNA library is presented in the context of a plasmid vector. This inherently provides convenient PCR primer recognition sites flanking the genomic DNA fragments, allowing for rapid and efficient amplification of genomic DNA sequences identified and isolated by the methods of the invention. Previous methods of analyzing DNA-protein interactions in vitro used genomic DNA fragments alone, without cloning them into plasmid vector, thus necessitating the use of inherently inefficient methods (e.g., ligation of primer sites) for later detecting and identifying genomic DNA fragments that interacted with the protein of interest. Fifth, the methods of this invention overcome the obstacles to using a genomic DNA library cloned into a conventional plasmid vector by using a vector engineered specifically to eliminate the drawbacks of conventional vectors. Finally, microarrays are not required, so the analysis is not limited to the regions of the genome present on a microarray chip nor does it require purchasing expensive instruments, reagents, or experienced personnel.

The methods of the present invention bear similarities to two existing methods: the yeast one-hybrid system (Li & Herskowitz, 1993) and the Systematic Evolution of Ligands by Exponential Enrichment (SELEX) (Ellington & Szostak, 1990; Tuerk & Gold, 1990). However, the yeast one-hybrid system uses yeast cells and an oligonucleotide containing a known DNA recognition site to screen a cDNA library for unknown DNA-binding proteins. The SELEX technique normally uses a randomly generated library of oligonucleotide fragments, which bear 18 to 21 invariant nucleotides on each end to serve as primer recognition sites, to identify the DNA recognition sequence of a known DNA-binding protein. In contrast, the methods of the present invention employ a known DNA-binding protein to screen a genomic DNA library—the library being comprised of genomic DNA fragments cloned into a plasmid vector—for regulatory elements and their variants that are bound by the protein and that may contain previously unidentified DNA recognition sequences specific for the DNA-binding protein of interest. Although the present invention, like the SELEX technique, features primer recognition sites to facilitate amplification of genomic DNA inserts, the SELEX technique does not also provide a plasmid vector. Use of plasmid vector as described herein greatly facilitates the methods of this invention by providing means for amplifying the genomic DNA library (e.g., by cloning it into bacteria for amplification and isolation, which cannot be done with the DNA libraries of the SELEX technique). Therefore, although certain elements of the present invention bear similarities to existing methods, the methods of the present invention are distinct from other methods in that they involve a stable genomic library present in a plasmid vector and are directed at identifying DNA regulatory elements, not just at identifying a synthetic DNA recognition sequence homolog or an unknown DNA-binding protein.

The invention features, in one aspect a method for identifying genomic DNA ligands of a target protein from a genomic DNA library, wherein the method comprises: (a) providing a genomic DNA library, wherein the library is comprised of genomic DNA fragments cloned into a plasmid vector; (b) contacting the genomic DNA library with the target protein, wherein the genomic DNA fragments cloned into a plasmid vector having a higher affinity for the target protein relative to the genomic DNA library may be partitioned from the remainder of the genomic DNA library; (c) partitioning the higher-affinity genomic DNA fragments—the genomic DNA ligands—cloned into a plasmid vector from the remainder of the genomic DNA library; (d) amplifying the higher-affinity genomic DNA fragments cloned into a plasmid vector, in vitro, to yield a genomic DNA ligand-enriched mixture of genomic DNA fragments cloned into a plasmid vector, whereby genomic DNA ligands that bind the target protein may be identified.

In this aspect of the invention, the genomic DNA library is preferably a stable genomic DNA library. Steps (b) through (d) are optionally but preferably repeated, using the genomic DNA ligand-enriched mixture of each successive repeat as many times as required to yield a desired level of genomic DNA ligand enrichment, whereby genomic DNA ligands that bind the target protein may be identified. As desired, the target protein may be a fusion protein comprising a known or putative DNA-binding protein and an epitope tag selected from but not limited to the group consisting of GST tag, HA tag, Myc tag, FLAG tag, and His tag. The genomic DNA fragments comprising the stable genomic DNA library may be derived from any source, including but not limited to mouse and human cells.

An additional feature of the invention is a plasmid vector comprised of a marker gene, a ROP gene, and at least two terminator sequences, wherein the at least two terminator sequences flank the genomic DNA cloned into the plasmid vector. In a preferred aspect, the plasmid vector is pSMART®LC-Kan (pSMART-LC-Kan).

Additionally, the target protein may be immobilized on a solid support (e.g., MagneSphere®, agarose, or Sepharose™ beads), preferably via an intervening antibody specific for the known or putative DNA-binding protein, but more preferably via an antibody (e.g., anti-HA) or other moiety (e.g., glutathione, or Nickel-NTA) specific for the epitope tag. If desired, partitioning of the higher-affinity genomic DNA fragments cloned into a plasmid vector from the remainder of the genomic DNA library may be accomplished by centrifugation or a magnetic stand.

The conditions under which the higher-affinity genomic DNA fragments cloned into a plasmid vector may be amplified can vary in any way desired by the practitioner. For example, the identity and concentration of the PCR enzyme may be varied, and the melting, extension, and annealing times and temperatures may all be varied according to practitioner preference, in order to obtain amplified product suitable for further rounds of selection according to the methods of the present invention.

The genomic DNA ligands that bind the target protein may be identified by any conventional techniques, including but not limited to gel electrophoresis, direct sequencing, restriction enzyme analysis, and DNA hybridization. A preferred method of identification is accomplished by processing the PCR product with a PCR purification kit (or by gel purification), cloning the PCR product into a standard cloning vector using standard techniques, transforming it into E. coli and plating on selective media, recovering plasmid DNA from transformed E. coli, sequencing at least a portion of the inserted DNA, and comparing the sequence obtained against appropriate DNA databases (e.g., via BLAST search).

The genomic DNA ligands identified by the methods of this invention may also be screened for false positive results in a yeast one-hybrid reporter system, for example, to determine whether the test DNA-binding protein actually interacts with the genomic DNA ligand identified by the methods of this invention. The method for identifying false positives involves providing a population of competent cells wherein a plurality of the cells of said population contain: (i) a reporter gene operably linked to the genomic DNA ligand; (ii) a fusion gene, wherein the fusion gene expresses a hybrid protein, said hybrid protein comprising the test DNA-binding protein covalently bonded to a gene activating moiety; and (b) detecting expression of the reporter gene as a measure of the ability of the target DNA-binding protein to interact with the genomic DNA ligand sequence, wherein the genomic DNA ligand is derived from the methods according to this invention.

To eliminate false-positives, wild-type yeast are first transformed using standard techniques with a bait vector carrying the coding sequence of the target DNA-binding protein. Positive transformants are selected by plating on synthetic minimal media lacking leucine (assuming the bait vector carries a LEU2 gene). One colony is then selected and used to propagate a new batch of cells, which are then transformed with reporter vector pKAD202 (SEQ ID NO:1) containing the genomic DNA ligand. Doubly-transformed yeast are then plated on synthetic minimal galactose media lacking leucine, tryptophan, and histidine. The resulting colonies are then replica-plated onto plates containing an optimal concentration of 3-aminotriazole (“3-AT,” where the optimal concentration is determined in prior control experiments). Colonies that grow under these conditions are further tested according to the steps below.

First, activation of the HIS3 reporter, resulting from binding of the target DNA-binding protein to genomic DNA ligand cloned into pKAD202, is confirmed by re-plating the clones onto galactose plates lacking leucine, tyrptophan, and histidine, and supplemented with the optimal 3-AT concentration, to verify the results.

Second, the positive colonies are streaked onto dextrose plates lacking leucine, tryptophan, and histidine. As the expression of the target DNA-binding protein is under the control of a galactose-inducible promoter, the positive clones should not grow on the dextrose plates. The pKAD202 vector is then isolated from the colonies that pass the second round of screening. Briefly, the positive colonies are grown in minimal media, and standard techniques are used to isolate plasmid DNA from the yeast. The resulting plasmid DNA—the pKAD202 vector containing a genomic DNA ligand—is transformed into E. coli, which are selected for by growth on LB plates containing kanamycin.

Third, the isolated reporter vector is re-transformed into yeast alone (i.e., without any other vector). The single transformants are tested using the initial screening process, as described, but with the addition of leucine to all media. The pKAD202 vector should not rescue the cells grown under the selective conditions (lacking histidine, but containing 3-AT). Finally, the isolated reporter vector is then co-transformed with the bait vector into a fresh growth of yeast, and the double transformants are tested as described previously. This test confirms that the original ability to grow in the absence of histidine did not result from a yeast reversion.

Clones that pass all rounds of false-positive tests are considered true positive interactions. The multiple cloning site of the pKAD202 vector from each positive colony may then be sequenced to identify the genomic sequence bound by the transcription factor.

Definitions

In the following description, terms relating to recombinant DNA technology are used. The following definitions are provided to give a clear understanding of the specification and appended claims.

By “gene” is meant a nucleic acid (e.g., deoxyribonucleic acid, or “DNA”) sequence that comprises coding sequences necessary for the production of a polypeptide or precursor (e.g., messenger RNA, or “mRNA”). The polypeptide may be encoded by a full length coding sequence or by any portion of the coding sequence, so long as the desired activity or functional properties (e.g., enzymatic activity, ligand binding, signal transduction, etc.) are retained. The term also encompasses the coding region of a structural gene and the sequences located adjacent to the coding region on both the 5′ and 3′ ends, for a distance of about 1 kb on either end, such that the gene is capable of being transcribed into a full-length mRNA. The sequences located 5′ of the coding region and which are present on the mRNA are referred to as 5′ untranslated sequences, and form the 5′ untranslated region (5′ UTR). The sequences located 3′ or downstream of the coding region and which are present on the mRNA are referred to as 3′ non-translated sequences, and form the 3′ untranslated region (3′ UTR). The term “gene” encompasses both cDNA and genomic forms of a gene. The genomic form or clone of a gene usually contains the coding region interrupted with non-coding sequences termed “introns” (also called “intervening regions” or “intervening sequences”). Introns are segments of a gene which are transcribed into nuclear RNA (hnRNA); introns may contain regulatory elements such as enhancers. Introns are removed or “spliced out” from the nuclear or primary transcript, and therefore are absent from the mRNA transcript. mRNA functions during translation to specify the sequence or order of amino acids in a nascent polypeptide.

By “nucleotide” is meant a monomeric structural unit of nucleic acid (e.g., DNA or RNA) consisting of a sugar moiety (a pentose: ribose, or deoxyribose), a phosphate group, and a nitrogenous heterocyclic base. The base is linked to the sugar moiety via a glycosidic bond (at the 1′ carbon of the pentose ring) and the combination of base and sugar is called a nucleoside. When the nucleoside contains a phosphate group bonded to the 3′ or 5′ position of the pentose, it is referred to as a nucleotide. When the nucleotide contains one such phosphate group, it is referred to as a nucleotide monophosphate; with the addition of two or three such phosphate groups, it is called a nucleotide diphosphate or triphosphate, respectively. The most common, nucleotide bases are derivatives of purine or pyrimidine, with the most common purines being adenine and guanine, and the most common pyrimidines being thymidine, uracil, and cytosine. A sequence of operatively linked nucleotides is typically referred to herein as a “base sequence” or “nucleotide sequence” or “nucleic acid sequence,” and is represented herein by a formula whose left-to-right orientation is in the conventional direction of 5′-terminus to 3′-terminus. A “test nucleic acid sequence” is a nucleic acid sequence used according to the methods of the present invention to measure or test interaction between said nucleic acid sequence and a protein. The test nucleic acid sequence may be a genomic DNA fragment.

By “polynucleotide molecule” is meant a molecule comprised of multiple nucleotides. Nucleotides are the basic unit of DNA, and consist of a nitrogenous base (adenine, guanine, cytosine, or thymine), a phosphate molecule, and a deoxyribose molecule. When linked together, they form polynucleotide molecules.

DNA molecules are said to have “5′ ends” and “3′ ends” because mononucleotides are joined to make oligonucleotides in a manner such that the 5′ phosphate of one mononucleotide pentose ring is attached to the 3′ oxygen of its neighbor in one direction, via a phosphodiester linkage. Therefore, an end of an oligonucleotide is referred to as the “5′ end” if its 5′-phosphate is not linked to the 3′ oxygen of a mononucleotide pentose ring. Alternatively, it is the “3′ end” if its 3′ oxygen is not linked to a 5′ phosphate of a subsequent mononucleotide pentose ring. These ends are also referred to as “free” ends because they are not linked to upstream or downstream mononucleotides, respectively. A double stranded nucleic acid molecule may also be said to have 5′- and 3′ ends, wherein the “5′” refers to the end containing the accepted beginning of the particular region, gene, or structure, and the “3′” refers to the end downstream of the 5′ end. A nucleic acid sequence, even if internal to a larger oligonucleotide, may also be said to have 5′ and 3′ ends, although these ends are not free ends. In such a case, the 5′ and 3′ ends of the internal nucleic acid sequence refer to the 5′ and 3′ ends that said fragment would have were it isolated from the larger oligonucleotide. In either a linear or circular DNA molecule, discrete elements may be referred to as being “upstream” or 5′ of the “downstream” or 3′ elements. Ends are said to “compatible” if: a) they are both blunt or contain complementary single strand extensions (such as that created after digestion with a restriction endonuclease); and b) at least one of the ends contains a 5′ phosphate group. Compatible ends are therefore capable of being ligated by a double stranded DNA ligase (e.g., T4 DNA ligase) under standard conditions. Nevertheless, blunt ends may also be ligated.

By “promoter” is meant a DNA sequence usually found at the 5′ region of a gene, proximal to the start codon. Transcription of an adjacent gene is initiated at the promoter region. If the promoter is an inducible promoter, the rate of transcription increases in response to an inducing agent.

By “minimal promoter” is meant a promoter is the noncoding sequence upstream (5′ direction) of a gene, providing a site for RNA polymerase to bind and initiate transcription. A minimal promoter is the minimal elements of a promoter, including a TATA box and transcription initiation site, and is inactive unless regulatory enhancer elements are situated upstream.

By “enhancer” is meant a regulatory sequence of DNA that may be located a great distance (thousands of base pairs) upstream or downstream from the gene it controls, or even within an intron of the gene it controls. Binding of DNA-binding proteins to an enhancer influences the rate of transcription of the associated gene.

By “operably linked” is meant that nucleic acid sequences or proteins are operably linked when placed into a functional relationship with another nucleic acid sequence or protein. For example, a promoter sequence is operably linked to a coding sequence if the promoter promotes transcription of the coding sequence. As a further example, a repressor protein and a nucleic acid sequence are operably linked if the repressor protein binds to the nucleic acid sequence. Additionally, a protein may be operably linked to a first and a second nucleic acid sequence if the protein binds to the first nucleic acid sequence and so influences transcription of the second, separate nucleic acid sequence. Generally, “operably linked” means that the DNA sequences being linked are contiguous, although they need not be, and that a gene and a regulatory sequence or sequences (e.g., a promoter) are connected in such a way as to permit gene expression when the appropriate molecules (e.g., transcriptional activator proteins—transcription factors—or proteins which include transcriptional activator domains) are bound to the regulatory sequence or sequences.

By “genomic DNA” is meant all the DNA sequences comprising the genome (the total genetic information carried) of a cell or organism

By “genomic DNA library” is meant a collection of genomic DNA that includes all the DNA sequences of a given species (e.g., a human genomic DNA library, or a simply human genomic library). For example, human genomic double-stranded DNA is cleaved with restriction endonuclease or mechanically sheared (e.g., by sonication), generating millions of “genomic DNA fragments.” These fragments are cloned (inserted via ligation) into plasmids, thus creating recombinant DNA molecules. The recombinant molecules are introduced in to bacteria by standard means known in the art, generating millions of different colonies of transfected bacterial cells. Each of these colonies is clonally derived from a single ancestor cell, and so contains many copies of a particular region of the fragmented genome. The plasmids are referred to as containing a genomic DNA clone, and the collection of plasmids is a genomic DNA library. A genomic DNA library is said to be “stable” when the library is constructed in such a manner that the genomic DNA insert does not promote unwanted transcription into the vector housing the library, which would induce recombination and destabilization of the vector, and the vector is maintained at a low copy number. For example, but without limitation, the vector may lack a promoter upstream of the inserted genomic DNA, it may contain terminator sequences configured to flank the inserted genomic DNA, and it may contain a CEN4/ARS6 low-copy-number yeast origin of replication. A preferred example of such a vector is pSMART®LCKan (Accession #AF532106).

By “genomic DNA ligand” is meant a stretch of genomic DNA that provides or represents a binding site for a DNA-binding protein (i.e., a segment of DNA that is necessary and sufficient to specifically interact with a given polypeptide, such as a DNA-binding protein). The portion of the DNA-binding protein that specifically interacts with the genomic DNA ligand is referred to as a “ligand binding domain” or “DNA-binding domain.”

By “DNA-binding domain” or “DNA-binding moiety” is meant a polypeptide sequence or cluster which is capable of directing specific polypeptide binding to a particular DNA sequence (i.e., to a genomic DNA ligand). The term “domain” in this context is not intended to be limited to a single discrete folding domain. Rather, consideration of a polypeptide as a “DNA-binding domain” for use in the methods of this invention can be made simply by the observation that the polypeptide has specific DNA binding activity or that the polypeptide shares sequence similarity with proteins having known DNA-binding activity.

By “protein” or “polypeptide” is meant a sequence of amino acids of any length, constituting all or a part of a naturally-occurring polypeptide or peptide, or constituting a non-naturally occurring polypeptide or peptide (e.g., a randomly generated peptide sequence or one of an intentionally designed collection of peptide sequences). A “test protein” or “test polypeptide” is a protein used according to the methods of the present invention to measure or test interaction between nucleic acids and said test protein or test polypeptide.

By “expression” or “gene expression” is meant transcription (e.g. from a gene) and, in some cases, translation of a gene into a protein, or “gene product.” In the process of expression, a DNA chain coding for the sequence of gene product is first transcribed to a complementary RNA, which is often a messenger RNA, and, in some cases, the transcribed messenger RNA is then translated into the gene product—a protein. The terms are also used to mean the degree to which a gene is active in a cell or tissue, measured by the amount of mRNA in the tissue and/or the amount of protein expressed.

By “DNA-binding protein” is meant any of numerous proteins which can or may specifically interact with a nucleic acid. For example, a DNA-binding protein used in the invention can be the portion of a transcription factor which specifically interacts with a nucleic acid sequence in the promoter of a gene. Alternatively, the DNA-binding protein can be any protein which specifically interacts with a sequence which is naturally-occurring or artificially inserted into the promoter of a reporter gene. Where protein/DNA interactions are characterized, the DNA-binding protein can be covalently bonded to a solid support (e.g., the DNA-binding protein may be expressed as a fusion protein, bearing an epitope tag, which epitope tag may facilitate binding to the solid support, which may be agarose beads). A “test protein” may be shown to be a “DNA-binding protein” by the methods of the invention.

By “fusion” or “hybrid” protein, DNA molecule, or gene is meant a chimera of at least two covalently bonded polypeptides or DNA molecules

As used herein, the terms “vector” or “plasmid” or “plasmid vector” are used in reference to extra-chromosomal nucleic acid molecules capable of replication in a cell and to which an insert sequence can be operatively linked so as to bring about replication of the insert sequence. Vectors are used to transport DNA sequences into a cell, and some vectors may have properties tailored to produce protein expression in a cell, while others may not. A vector may include expression signals such as a promoter and/or a terminator, a selectable marker such as a gene conferring resistance to an antibiotic, and one or more restriction sites into which insert sequences can be cloned. Vectors can have other unique features (such as the size of DNA insert they can accommodate). A plasmid or plasmid vector is an autonomously replicating, extrachromosomal, circular DNA molecule (usually double-stranded) found mostly in bacterial and protozoan cells. Plasmids are distinct from the bacterial genome, although they can be incorporated into a genome, and are often used as vectors in recombinant DNA technology.

The term “prokaryotic termination sequence,” “transcriptional terminator,” “terminator sequence,” or “terminator” refers to a nucleic acid sequence, recognized by an RNA polymerase, that results in the termination of transcription. Prokaryotic termination sequences commonly comprise a GC-rich region that has a twofold symmetry, followed by an AT-rich sequence. Commonly used prokaryotic termination sequences are the ADH1, T7, T3, and TonB termination sequences. A variety of termination sequences are known in the art and may be employed in the nucleic acid constructs of the present invention, including the T_{INT}, T_{L1}, T_{L2}, T_{R1}, R_{R2}, T_{6S} termination signals derived from the bacteriophage lambda, and termination signals derived from bacterial genes such as the trp gene of E. coli.

As used herein, the terms “selectable marker,” “selectable marker sequence,” “selectable marker gene,” or “marker gene” refers to a gene or other DNA fragment that encodes or provides an activity conferring the ability to grow or survive in what would otherwise be a deleterious environment. For example, a selectable marker may confer resistance to an antibiotic or drug (e.g., ampicillin or kanamycin) upon the host cell in which the selectable marker is expressed. An origin of replication (Ori) may also be used as a selectable marker enabling propagation of a plasmid vector. Further examples include, without limitation, kanamycin resistance genes and ampicillin resistance genes.

By “ROP gene” is meant a gene encoding the repressor of primer protein, which regulates plasmid DNA replication by modulating the initiation of transcription. It is used to keep plasmid copy number low, thus preventing or minimizing potentially toxic effects to host cells that may arise from cloned genomic DNA fragments.

The term “expression vector” as used herein refers to a recombinant DNA molecule containing a desired coding sequence and appropriate nucleic acid sequences necessary for expression of the operably linked coding sequence (e.g. an insert sequence that codes for a product) in a particular host cell. Nucleic acid sequences necessary for expression in prokaryotes usually include a promoter, an operator (optional), and a ribosome binding site, often along with other sequences.

The term “epitope tag” is meant to include, but not be limited to a GST (glutathione-S-transferase) tag, an HA (haemagglutinin) tag, a Myc tag, a FLAG tag, and a His tag. The preceding listing of such epitope tag polypeptides is meant to be illustrative and not limiting, and there is a large and ever-increasing selection of such epitope polypeptides that are substitutable for substitution with those specifically described herein. One skilled in the art is capable of making desired substitutions without undue experimentation.

As used herein, the term “origin of replication” refers to a DNA sequence conferring functional replication capabilities in a host cell. Examples include, but are not limited to, normal or non-conditional origin of replications such as the ColE1 origin, and its derivatives, which are functional in a broad range of host cells. An origin of replication may be a “high copy number” or “low copy number” origin of replication.

As used herein, the term “non-promoter sequence” refers to any nucleic acid sequence that is unable to serve as an operable promoter element for initiating transcription in a given host cell, such as a bacterial host cell, or a eukaryotic host cell. In preferred embodiments, the host cell in which the non-promoter sequence is unable to serve as an operable promoter is an E. coli host cell.

As used herein, the terms “insert sequence” or “foreign DNA” refer to any nucleic acid sequences that are capable of being placed in a vector. Examples include, but are not limited to, random DNA libraries and known nucleic acid sequences. A particular “insert sequence” or “foreign DNA” may refer to a pool or a member of a pool of identical nucleic acid molecules, a pool or a member of a pool of non-identical nucleic acid molecules, or a specific individual nucleic acid molecule (e.g., nucleotide sequences encoding Pax3, FKHR, or other proteins).

By “covalently bonded” is meant that two molecules (e.g., DNA molecules or proteins) are joined by covalent bonds, directly or indirectly. For example, the “covalently bonded” proteins or protein moieties may be immediately contiguous, or they may be separated by stretches of one or more amino acids within the same hybrid protein.

By “target protein” or “target DNA molecule” is meant a peptide, protein, domain of a protein, or nucleic acid molecule whose function (i.e., whose ability to interact with a second molecule) is being characterized with the methods of the invention. A target protein may further comprise an epitope tag, and so exist as a fusion protein. Such a fusion protein or target fusion protein may also be “immobilized” on a solid support (e.g., agarose or Sepharose®), which means that the fusion protein has been purified or isolated by affinity chromatography, using a solid support that has attached to it a moiety (e.g., glutathione) with affinity for the epitope tag (e.g., a GST epitope tag).

The terms “interact” and “interacting” are meant to include detectable interactions between molecules, and are intended to include protein interactions with nucleic acid, detectable by the methods of the present invention.

The terms “identification,” “identifying,” “determining,” and “detecting” relate to the ability of the person skilled in the art to detect and distinguish interaction between genomic DNA ligands and target proteins from false positive interactions due to non-specific interaction, and optionally to characterize at least one of said interacting genomic DNA ligands by one or a set of unambiguous features including but not limited to direct sequencing. Preferably, said genomic DNA ligands are characterized by the DNA sequence encoding them, upon isolation, polymerase chain reaction amplification, and sequencing of the respective DNA molecules, according to the methods of the present invention.

By “putative” is meant that the primary, secondary, or tertiary structure of a DNA fragment or a protein bears regions that match primary, secondary, or tertiary structure of known DNA-binding proteins or DNA ligands.

As used herein, the term “host cell” or “competent cell” refers to any cell that can be transformed with heterologous DNA (such as a plasmid vector). Examples of host cells include, but are not limited to E. coli strains that contain the F or F′ factor (e.g., DH5αF or DH5αF′) or E. coli strains that lack the F or F′ factor (e.g., DH10B).

The term “population” in the context of competent cells or host cells refers to the whole number of such cells in a given sample, colony, or clone. It may be the total of such cells occupying an area on solid medium or some other limited and separated space (e.g., an eppendorf flask). It may also refer to a body, grouping, or cluster of such cells having a particular characteristic in common (e.g., Leucine auxotrophy), or a group of such cells from which samples are taken for measurement.

The term “isolated cell” as used herein refers to a host cell that is selected from amongst other host cells according to at least one identifiable phenotype (e.g., expression of a reporter gene confering ability to grow on synthetic medium lacking leucine), and set apart from other host cells (e.g., by manually removing and transfering a colony from a plate on which cultures are grown). The processes involved in identifying, selecting and setting apart an isolated cell comprise “isolating a cell.”

The term “isolating plasmid DNA” as used herein refers to removing cellular material, or culture medium when the plasmid DNA is produced by recombinant techniques, or removing chemical precursors or other chemicals when chemically synthesized (e.g., after PCR). An “isolated plasmid DNA,” then, is substantially free of culture medium, cellular material, chemical precursors, or other chemicals, depending on the method of production.

The term “transformation” or “transfection” as used herein refers to the introduction of foreign DNA into cells (e.g. prokaryotic cells, or host cells). Transformation may be accomplished by a variety of means known to the art including calcium phosphate-DNA co-precipitation, DEAE-dextran-mediated transfection, polybrene-mediated transfection, electroporation, microinjection, liposome fusion, lipofection, protoplast fusion, retroviral infection, and biolistics.

By “restriction endonuclease” and “restriction enzyme” is meant enzymes (e.g. bacterial enzymes), each of which cut double-stranded DNA at or near a specific nucleotide sequence (a cognate restriction site). Examples include, but are not limited to, BamHI, EcoRV, HindIII, HincII, NcoI, SalI, and NotI.

By “restriction” is meant cleavage of DNA by a restriction enzyme at its cognate restriction site.

By “restriction site” is meant a particular DNA sequence recognized by its cognate restriction endonuclease.

As used herein, the term “purified” or “to purify” refers to the removal of contaminants from a sample. For example, plasmids are grown in bacterial host cells and the plasmids are purified by the removal of host cell proteins, bacterial genomic DNA, and other contaminants. The percent of plasmid DNA is thereby increased in the sample. In the case of nucleic acid sequences, “purify” refers to isolation of the individual nucleic acid sequences from each other.

As used herein, the terms “sequencing” or “DNA sequence analysis” refers to the process of determining the linear order of nucleotides bases in a nucleic acid sequence (e.g. insert sequence) or clone. These units are the C, T, A, and G bases. Generally, to sequence a section of DNA, the DNA sequence of a short flanking region, i.e., a primer binding site, must be known beforehand. One method for sequencing is called dideoxy sequencing (or Sanger sequencing). One example for performing dideoxy sequencing uses the following reagents: 1) the DNA that will be used as a template (e.g. insert sequence); 2) a primer that corresponds to a known sequence that flanks the unknown sequence; 3) DNA nucleotides, to synthesize and elongate a new DNA strand; 4) dideoxynucleotides that mimic the G, A, T and C building blocks to incorporate into DNA, but that prevent chain elongation, thus acting as termination bases for a DNA polymerase (the four different dideoxynucleotides also may be labeled with different fluorescent dyes for automated DNA sequence analysis); and 5) a nucleic acid polymerizing agent (e.g., DNA polymerase or Taq polymerase, both of which are enzymes that catalyze synthesis of a DNA strand from another DNA template strand). When these reagents are mixed, the primer aligns with and binds the template at the primer binding site. The polymerizing agent then initiates DNA elongation by adding the nucleotide building blocks to the 3′ end of the primer. Randomly, a dideoxynucleotide will integrate into a growing chain. When this happens, chain elongation stops and, if the dideoxynucleotide is fluorescently labeled, the label will be also be attached to the newly generated DNA strand. Multiple strands are generated from each template, each strand terminating at a different base of the template. Thus, a population is produced with strands of different sizes and different fluorescent labels, depending on the terminal dideoxynucleotide incorporated as the final base. This entire mix may, for example, be loaded onto a DNA sequencing instrument that separates DNA strands based on size and simultaneously uses a laser to detect the fluorescent label on each strand, beginning with the shortest. The sequence of the fluorescent labels, read from the shortest fragment to the longest, corresponds to the sequence of the template. The reading may be done automatically, and the sequence may be captured and analyzed using appropriate software. The term “shotgun cloning” refers to the multi-step process of randomly fragmenting target DNA into smaller pieces and cloning them en masse into plasmid vectors.

As used herein, the terms “to clone,” “cloned,” or “cloning” when used in reference to an insert sequence and vector, mean ligation of the insert sequence into a vector capable of replicating in a host cell. The terms “to clone,” “cloned,” or “cloning” when used in reference to an insert sequence, a vector, and a host cell, refer generally to making copies of a given insert sequence. In this regard, to clone a piece of DNA (e.g., insert sequence), one would insert it into a vector (e.g., ligate it into a plasmid, creating a vector-insert construct) which may then be put into a host (usually a bacterium) so that the plasmid and insert replicate with the host. An individual bacterium is grown until visible as a single colony on nutrient media. The colony is picked and grown in liquid culture, and the plasmid containing the “cloned” DNA (the sequences inserted into the vector) is re-isolated from the bacteria, at which point there may be many millions of copies of the vector-insert construct. The term “clone” can also refer either to a bacterium carrying a cloned DNA, or to the cloned DNA itself.

As used herein, the term “library” refers to a collection of insert sequences residing in transfected cells, each of which contains a single insert sequence from a genome, sub-cloned into a vector.

The term “electrophoresis” refers to the use of electrical fields to separate charged biomolecules such as DNA, RNA, and proteins. DNA and RNA carry a net negative charge because of the numerous phosphate groups in their structure. Proteins carry a charge that changes with pH, but becomes negative in the presence of certain chemical detergents. In the process of “gel electrophoresis,” biomolecules are put into wells of a solid matrix typically made of an inert porous substance such as agarose. When this gel is placed into a bath and an electrical charge applied across the gel, the biomolecules migrate and separate according to size, in proportion to the amount of charge they carry. The biomolecules can be stained for viewing (e.g., with ethidium bromide or with Coomassie dye) and isolated and purified from the gels for further analysis. Electrophoresis can be used to isolate pure biomolecules from a mixture, or to analyze biomolecules (such as for DNA sequencing).

As used herein, the terms “PCR” and “amplifying” refer to the polymerase chain reaction method of enzymatically “amplifying” or copying a region of DNA. This exponential amplification procedure is based on repeated cycles of denaturation, oligonucleotide primer annealing, and primer extension by a DNA polymerizing agent such as a thermostable DNA polymerase (e.g. the Taq or Tfl DNA polymerase enzymes isolated from Thermus aquaticus or Thermus flavus, respectively).

As used herein, the term “oligonucleotide,” refers to a short length of single-stranded polynucleotide chain. Oligonucleotides are typically less than 100 residues long (e.g., between 15 and 50), however, as used herein, the term is also intended to encompass longer polynucleotide chains. Oligonucleotides are often referred to by their length. For example a 24 residue oligonucleotide is referred to as a “24-mer”. Oligonucleotides can form secondary and tertiary structures by self-hybridizing or by hybridizing to other polynucleotides. Such structures can include, but are not limited to, duplexes, hairpins, cruciforms, bends, and triplexes.

As used herein, the term “primer” refers to an oligonucleotide, whether occurring naturally as in a purified restriction digest or produced synthetically, which is capable of acting as a point of initiation of nucleic acid synthesis when placed under conditions in which synthesis of a primer extension product which is complementary to a nucleic acid strand is induced, (i.e., in the presence of nucleotides and an inducing agent such as DNA polymerase and at a suitable temperature and pH). The primer is preferably single stranded for maximum efficiency in amplification, but may alternatively be double stranded. If double stranded, the primer is first treated to separate its strands before being used to prepare extension products. Preferably, the primer is an oligodeoxyribonucieotide. The primer must be sufficiently long to prime the synthesis of extension products in the presence of the inducing agent. The exact lengths of the primers will depend on many factors, including temperature, source of primer, and the use of the method.

As used herein, the term “target,” in regards to PCR, refers to the region of nucleic acid bounded by the primers. Thus, the “target” is sought to be sorted out from other nucleic acid sequences. A “segment” is defined as a region of nucleic acid within the target sequence.

As used herein, the terms “PCR product,” “PCR fragment,” and “amplification product” refer to the resultant mixture of compounds after two or more cycles of the PCR steps of denaturation, annealing, and extension are complete. These terms encompass the case where there has been amplification of one or more segments of one or more target sequences.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 shows twenty-two independent genomic library clones, isolated from twenty-two separate E. coli colonies that were grown on LB agar containing kanamycin. Clones were linearized by EcoRV digest, and separated on a 1% agarose gel.

FIG. 2 is a schematic representation of methods of the present invention. For the sake of simplicity, the complete vector backbone is not shown; only short portions of vector bound to the 5′ and 3′ ends of the genomic DNA fragments are shown. The DNA-binding protein of interest is expressed as a fusion protein further comprising an epitope tag (e.g., glutathione S-transferase, or “GST”). The target DNA is initially supplied as a genomic DNA library in a high stability cloning vector (vector not shown). The use of a cloned library improves upon other similar methods because the vector itself provides defined PCR primer sites flanking the genomic DNA fragments. In the first round of incubation, the genomic DNA library is bound to the DNA-binding protein, and the bound complex is purified via the epitope tag (i.e., the epitope tag has affinity for a molecule attached to the solid support, and as the solid support is partitioned from the media, it pulls down everything else attached to it). Clones containing genomic DNA fragments that have bound to the DNA-binding protein of interest are eluted from the complex, and the inserts are amplified by PCR. The PCR product is used for additional rounds of binding and amplification, until a significant enrichment of genomic DNA fragments is obtained. After a final round of selection and amplification, the resulting genomic DNA is cloned into a standard bacterial cloning vector, transformed into bacteria, and the genomic DNA sequence is obtained by standard means.

FIG. 3 shows Pax3-specific binding and amplification of the TRP-1 and Msx2 promoters.

FIG. 4 shows FKHR-specific binding of a genomic fragment containing the known FKHR DNA recognition sequence (Clone #14) or no FKHR DNA recognition sequences (Clone #16).

FIG. 5 is a schematic representation of an optional enhancement of the methods of the present invention.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The invention features, in one aspect a method for identifying genomic DNA ligands of a target protein from a genomic DNA library, wherein the method comprises: (a) providing a genomic DNA library, wherein the library is comprised of genomic DNA fragments cloned into a plasmid vector; (b) contacting the genomic DNA library with the target protein, wherein the genomic DNA fragments cloned into a plasmid vector having a higher affinity for the target protein relative to the genomic DNA library may be partitioned from the remainder of the genomic DNA library; (c) partitioning the higher-affinity genomic DNA fragments cloned into a plasmid vector from the remainder of the genomic DNA library; (d) amplifying the higher-affinity genomic DNA fragments cloned into a plasmid vector, in vitro, to yield a genomic DNA ligand-enriched mixture of genomic DNA fragments cloned into a plasmid vector, whereby genomic DNA ligands that bind the target protein may be identified.

Preferably, but optionally, the method further comprises: (e) optionally repeating steps (b) through (d) using the genomic DNA ligand-enriched mixture of each successive repeat as many times as required to yield a desired level of genomic DNA ligand enrichment, whereby genomic DNA ligands that bind the target protein may be identified.

In certain preferred embodiments, the target protein may be immobilized on a solid support, for example, the target protein may be a fusion protein comprising an epitope tag, including but not limited to a GST (glutathione-5-transferase) tag, an HA (haemagglutinin) tag, a Myc tag, a FLAG tag, or a His tag, and a known or putative DNA-binding protein or fragment thereof, wherein the solid support provides means, including but not limited to glutathione, or HA-, Myc- or FLAG-specific antibodies, or copper, zinc, cobalt or nickel ions bound to the solid support, for covalently bonding to the epitope tag of the fusion protein, and wherein the solid support may be agarose or Sepharose®.

In another preferred embodiment, the plasmid vector is comprised of a marker gene, a ROP gene, an origin of replication, a blunt cloning site, and at least two terminator sequences, wherein the at least two terminator sequences flank the blunt cloning site, and wherein the genomic DNA fragments are cloned into the blunt cloning site of the plasmid vector.

In a more preferred embodiment, the plasmid vector is further comprised of a third terminator sequence downstream of the marker gene, wherein the marker gene may encode ampicillin or kanamycin resistance, and wherein the plasmid vector lacks a promoter between the first terminator sequence upstream of the blunt cloning site and the blunt cloning site.

In an even more preferred embodiment, the 5′ to 3′ order of the features of the plasmid vector are: a blunt cloning site, wherein genomic DNA fragments are cloned into the blunt cloning site; a first terminator sequence; a marker gene, wherein the marker gene may encode ampicillin or kanamycin resistance; a ROP gene; a second transcriptional terminator; an origin of replication; and a third transcriptional terminator.

In a most preferred embodiment, the plasmid vector is pSMART®LCKan (Accession # AF532106).

The following examples are provided to demonstrate and further illustrate certain preferred embodiments and aspects of the present invention, and are not to be construed as limiting the scope thereof.

### EXAMPLE 1

Preparation of the Mouse Genomic DNA Library

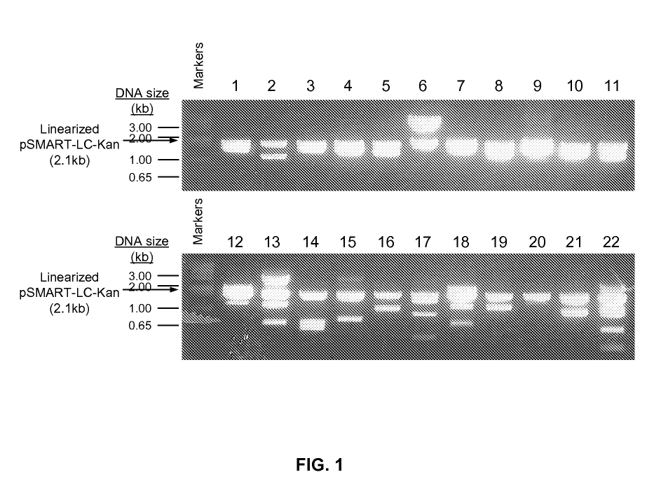

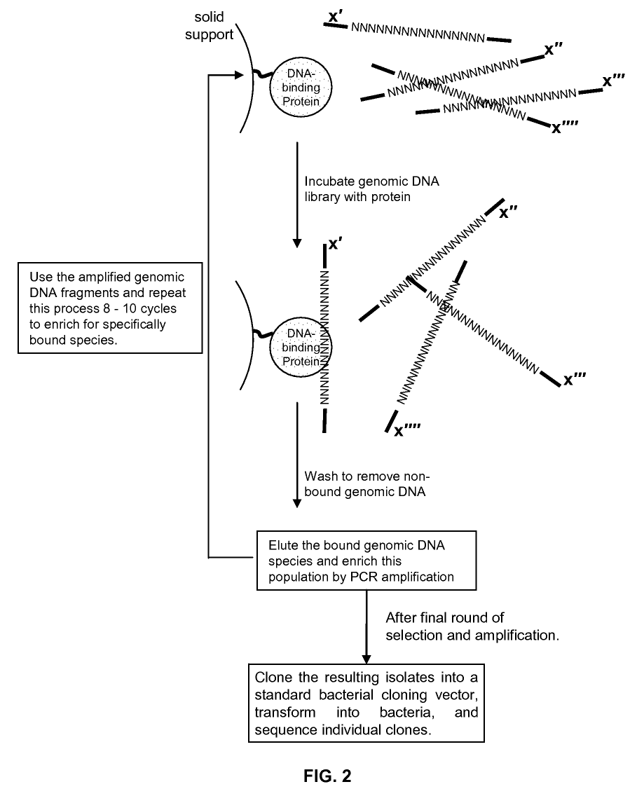

Initial attempts in our laboratory at creating a mouse genomic library in yeast vectors pHIS2 and pHR307a proved unsuccessful, due to instability inherent in these vectors. To circumvent this problem, the transcription-free pSMART®LC-Kan vector was used (FIG. 2). pSMART®LC-Kan (Lucigen Corp., Middleton, Wis.; Accession #AF532106) is a low-copy vector that contains strong transcriptional terminators flanking each of the individual elements of the vector. It also lacks an insertional indicator gene such as lacZ. The termination sequences increase the stability of the recombinant clone by minimizing vector-driven transcription of the inserted DNA as well as unintended transcription out of the DNA inserts by authentic or pseudo transcriptional promoters in E. coli. Mouse genomic DNA was sheared by sonication, end-repaired with a DNA Terminators End Repair Kit (Lucigen), and separated on a 1% agarose gel. DNA fragments between 0.5-2.0 kb were gel purified and cloned into the blunt cloning site of pSMART®LCKan, using a CloneSmart® Blunt Cloning Kit (Lucigen) according to the manufacturer's directions. The resulting ligated DNA was electroporated into ElectroMAX DH10B E. coli cells Invitrogen, Carlsbad, Calif.). An aliquot of the transformed bacteria was plated onto Luria broth (LB) agar plates containing kanamycin, and the remainder of the cells were saved as a frozen glycerol stock. Twenty-two individual colonies were selected and cultured separately in liquid LB medium containing kanamycin. FIG. 1 shows plasmid DNA that was isolated from each culture, subjected to restriction digest with EcoRV, and separated on a 1% agarose gel to determine insert frequency and size. The predicted size of the linearized, pSMART-LC-Kan parent vector (2.1 kb) is indicated. This analysis demonstrated that twenty-one of the twenty-two clones (950%) contained genomic DNA inserts between 0.65-2.0 kb. As seen in FIG. 1, Clone #20 had no insert. Sequencing of the inserts with SL1 forward primer 5′-CAGTCCAGTTACGCTGGAGTC-3′ (SEQ ID NO:2) demonstrated that each of these twenty-one clones derived from a unique piece of genomic DNA. The genomic library created in this manner contains approximately 3×10⁶ independent clones, with DNA inserts between 0.65-2.0 kb, providing an approximate 1.7-fold over-representation of the entire mouse genome.

### EXAMPLE 2

Expansion of the Genomic DNA Library

The mouse genomic library, prepared as described above, was expanded by plating the glycerol stock of bacteria, reserved from above and containing the library, onto 24.5×24.5 cm LB agar plates containing kanamycin, and incubating the plates at 37° C. overnight. The colony density was limited to approximately 20,000 colonies per plate to avoid overcrowding. The resulting colonies were scraped from the plate, and the DNA was isolated using a Qiagen Maxiprep kit (Qiagen, Valencia, Calif.). The resulting DNA was aliquoted and stored at −80° C.

### EXAMPLE 3

Preparation of the In Vitro PORE Positive Controls

The positive control regulatory elements for use with the transcription factor Pax3 were cloned as follows. The promoter sequence for the TRP-1 gene was amplified from mouse genomic DNA via PCR using Trp forward primer 5′-CGGGATCCGATATCAAGCTTTTACCACTGTGCCTTCTCC-3′ (SEQ ID NO:3) and Trp reverse primer 5′-CGACGCGTGATATCAGCTGTTAATTGCCCGAAGAG-3′ (SEQ ID NO:4). The promoter sequence for the Msx2 gene was amplified from mouse genomic DNA via PCR using Msx2 forward primer 5′-CGGGATCCGATATCTCTACCTAAATTCCCTGCTGAGGAGCTC-3′ (SEQ ID NO:5) and Msx2 reverse primer 5′-CGACGCGTGATATCTAACCGTGAAGCGTTGAGCACAGA-3′ (SEQ ID NO:6). The forward primers (SEQ ID NO:3 and SEQ ID NO:5) were engineered to contain unique BamHIH and EcoRV sites, while the reverse primers (SEQ ID NO:4 and SEQ ID NO:6) were engineered to contain unique MluI and EcoRV sites. Both the TrpI and Msx2 promoter elements are bound and activated by Pax3 (Galibert et al., 1999; Kwang et al., 2002). The resulting PCR-amplified products were TA-cloned by incubating 5 μl of the amplification product with 50 ng of the pCR®II linearized vector (Invitrogen, Carlsbad, Calif.) and 4.0 Weiss units of T4 DNA Ligase at 14° C. for a minimum of four hours. The pCR®II vector is a linearized vector with a one-base deoxythymidine overhang on the 3′-end of each vector strand. This vector is engineered to take advantage of the nontemplate-dependent activity of Taq polymerase that adds a single deoxyadenosine (A) to the 3′-ends of PCR products. The resulting ligated DNA was transformed into One Shot® Competent Cells (Invitrogen) and bacteria containing the ligated vector were selected on LB plates containing Ampicillin overnight at 37° C. Individual clones were picked, analyzed by restriction digest with EcoRV, and subsequently sequenced to confirm the PCR amplification process introduced no mutations. Finally, the regulatory elements were excised from pCR®II by EcoRV digest and cloned into the same site of pSMART®LCKan.

The positive control regulatory element for use with the transcription factor FKHR was isolated as follows. Sequence analysis of one of the individual clones isolated from the mouse genomic library described above (FIG. 1, Clone #14) fortuitously contained two copies of the FKHR cognate DNA recognition sequence (Furuyama et al., 2000). A BLAST search of this fragment identified it as being part of intron 1 of the Gab-1 gene, a protein implicated in the regulation of myogenic differentiation (Vasyutina et al., 2005; Mood et al., 2006; Fan et al., 2001). Taken together, these results suggested that this fragment would serve as a FKHR-dependent regulatory element and was subsequently used as a positive control for the In vitro PORE technique. As a negative control, one of the genomic library clones described above that did not contain the FKHR cognate DNA recognition sequence (Clone #16, FIG. 1) was also used.

### EXAMPLE 4

Creation of GST-Pax3 and GST-FKHR Fusion Proteins

The coding sequences for Pax3 and FKHR were cloned into expression vector pGEX-4T-2 (GE Healthcare Bio-Sciences Corp., Piscataway, N.J.) such that expression of these genes would lay in-frame with glutathione S-transferase (GST). Pax3 and FKHR cloned in this manner result in the production of a GST-Pax3 or GST-FKHR fusion protein.

The plasmids containing GST-Pax3 or GST-FKHR were transformed into Rosetta™ (DE3) (pLysS) E. coli host strain (Novagen, Madison, Wis.), and transformed E. coli were plated on LB agar plates containing ampicillin and chloramphenicol for overnight incubation at 37° C. The following day, single colonies were selected and transferred to individual vials each containing 5 mL of LB broth with 50 mg/L ampicillin and 34 mg/L chloramphenicol (LB Amp/Chlor), and placed in a 37° C. shaking incubator overnight. The following day, the overnight cultures from the shaking incubator were transferred to 250 mL fresh LB Amp/Chlor and returned to the 37° C. shaking incubator until the optical density (measured at a fixed wavelength of 600 nm, or “OD₆₀₀”) of the resulting culture reached about 0.6-1.0.

Bacterial expression of GST fusion proteins was induced by adding isopropyl-β-D-thiogalactopyranoside (“IPTG,” Sigma, St. Louis, Mo.) to the 250 mL cultures, to a final concentration of about 0.1 mM IPTG, and by returning the cultures to the 37° C. shaking incubator for about 3 additional hours. The cultures were removed from the shaking incubator, poured into centrifuge bottles, and centrifuged at about 5,000 rpm for 10 minutes, at 4° C. The resulting pellets were resuspended on ice, in ice-cold phosphate buffered saline (PBS) containing a 1× final concentration of Complete EDTA-free protease inhibitor cocktail (Roche Diagnostics, Indianapolis, Ind.), and lysed with CelLytic™ Express protein extraction formulation (Sigma, St. Louis, Mo.). Cellular debris was pelleted by centrifugation at about 5,000 rpm for 10 minutes, at 4° C. The overlying supernatant was removed and used immediately in the subsequent purification step.

GST fusion proteins for use in individual experiments were purified from supernatant, obtained as described above, by incubating supernatant with MagneSphere GST affinity resin (Promega Corporation, Madison, Wis.) overnight at 4° C. After overnight incubation, the resin was: 1) immobilized to the side of the tube, at 4° C., using a magentic immobilization stand; 2) the overlying supernatant was removed; and 3) fresh PBS at 4° C. was added. Steps 1 through 3 were repeated four times, after which the resin was immobilized a final time at 4° C. and the overlying supernatant removed, taking care to leave enough fluid that the resin remained wet. The resulting resin with bound GST-Pax3 or GST-FKHR (GST-Pax3 resin or GST-FKHR resin) was used as-is for the In vitro PORE technique.

### EXAMPLE 5

In Vitro PORE Analysis

The steps of the In vitro PORE technique are outlined in FIG. 2, and represent the steps followed in the positive control In vitro PORE analysis. FIG. 2 shows genomic DNA fragments (labeled as x′, x″, x′″, and x″″, to indicate that each fragment is different) cloned into a plasmid vector, according to the methods of the invention. For the sake of simplicity, the plasmid DNA is not fully shown. FIG. 2 also shows an epitope-tagged target protein (e.g., a GST-tagged Pax3) immobilized on a solid support, according to the methods of this invention. The stable genomic DNA library is incubated with the immobilized, epitope-tagged target protein. Non-bound DNA is removed by washing, and the genomic DNA fragments bound to the target protein are eluted, enriched by PCR amplification, optionally subjected to gel electrophoresis and gel purification, and then used to repreat the incubation steps with the same target protein. After PCR purification, or after optional gel electrophoresis and gel purification, the resulting DNA may be cloned into a standard bacterial cloning vector, cloned into bacteria, and amplified for sequencing of individual clones.

### EXAMPLE 6

Positive Control In Vitro PORE Analysis

Briefly, 100 ng of the Trp-1, Msx2, Clone #14, and Clone #16 each cloned into pSMART®LCKan vector were used for the first round of binding and selection, as shown schematically in FIG. 2. Each round of binding was carried out in 100 μl total reaction volume containing: 10 μl of bacterially expressed and purified glutathione S-Transferase (GST)-tagged Pax3 (Trp-1 and Msx2), GST-tagged FKHR (Clone #14 and #16), or GST protein alone as a negative control; and 100 ng of the Trp-1, Msx2, Clone #14, and Clone #16 each cloned into pSMART®LCKan vector, as appropriate. Each of the proteins was immobilized prior to commencement of the experiment using MagneSpere GST magnetic resin (Promega Corporation, Madison, Wis.).

Samples were gently agitated at room temperature for 30 min in In vitro PORE binding buffer (25 mM HEPES, 100 mM KCl, 0.2 mM EDTA, 1 mM MgCl₂ and 5% Glycerol) containing 5 μg Poly (dLdC) (Sigma, St. Louis, Mo.) and 5 μg bovine serum albumin to minimize non-specific interactions. Non-bound DNA was removed by washing the protein-bound resin four times with In vitro PORE binding buffer, after which the resulting washed resin was isolated using a magnetic stand, and resuspended in 50 μl of water. The bound DNA was eluted from the protein by boiling for 5 minutes, after which 10 μl of the eluted DNA was used as a template for a 50 μl PCR amplification reaction.

The PCR amplification was carried out with 1000 μM final concentrations of In vitro PORE forward primer 5′-CGTGAAGGTGAGCCAGTGAGTTGATTGCAGTCC-3′ (SEQ ID NO:7) and In vitro PORE reverse primer 5′-CGTGCCGATCAAGTCAAAAGCCTCCGGTCGG-3′ (SEQ ID NO:8). Amplification was performed using a GC-rich PCR amplification kit (Roche Biochemicals, Indianapolis, Ind.), according to the manufacturer's specifications, with 30 cycles at 94° C. for 1 minute, 68° C. for 5 minutes, and a final extension at 68° C. for 10 minutes. The PCR reaction product was then separated on a 1% agarose gel. The amplified band was excised from the gel and agarose removed by gel extraction using a QIAquick gel extraction kit (Qiagen, Valencia, Calif.). In the event that no amplified band was visible by staining with ethidium bromide and illumination with ultraviolet light, the portion of the gel corresponding to the expected size of the fragment was excised and cleaned up as described above. The extracted DNA was eluted in 50 μl of water, and 10 μl from the elution was used for the subsequent round of binding. Binding and amplification were carried out for two to three rounds of binding and amplification.

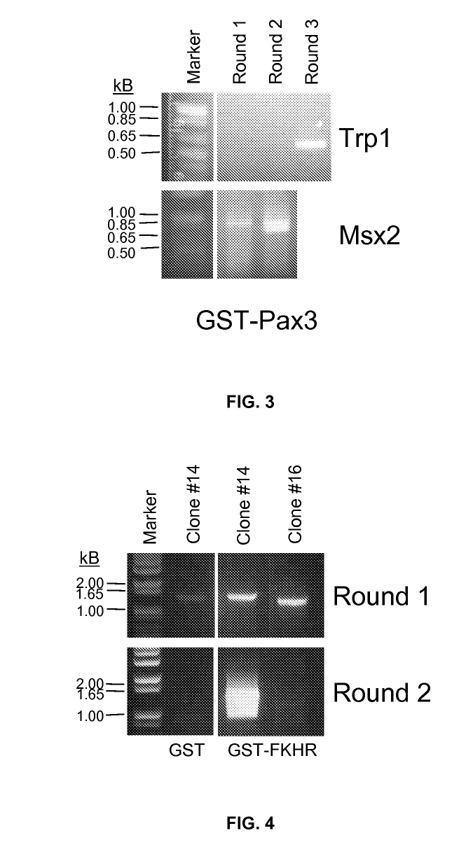

FIGS. 3 and 4 show the results obtainable with methods of the present invention, demonstrating that known DNA recognition sequences present in their native genomic context can be bound and amplified using the methods of the present invention. FIG. 3 shows Pax3-specific binding and amplification of the TRP-1 and Msx2 promoters. FIG. 4 shows FKHR-specific binding of a genomic fragment containing the known FKHR DNA recognition sequence (Clone #14), and the failure of FKHR to bind Clone #16, which contains no FKHR DNA recognition sequences. Bacterially expressed and purified GST-Pax3 or GST-FKHR were immobilized on the paramagnetic substrate MagneGST™Glutathione affinity resin (Promega, Madison, Wis.). DNA from the TRP-1 and Msx2 clones (100 ng each) was bound to the immobilized proteins. After extensive washing, the bound DNA was eluted from the protein and PCR amplified using flanking primers specific for the pSMART LCKan vector. The resulting PCR product was gel purified from a 1% agarose gel, and the purified DNA fragment was used for subsequent rounds of binding and amplification. When no amplified product was visible by ethidium bromide staining, the region of the gel corresponding to the predicted size of the fragment was excised, processed, and used for subsequent rounds of binding and amplification. We observed significant binding and amplification of both the TRP-1 and the Msx2 promoters by Pax3 after several rounds of the methods of the present invention. Binding and amplification were carried out for the indicated number of rounds in each of FIGS. 3 and 4. The low levels of amplification observed in FIG. 4 with Clone #16 in the presence of GST-FKHR and with Clone #14 in the presence of GST alone are the result of non-specific interactions. Nevertheless, these non-specific interactions disappeared with the second round of In vitro PORE and stand in stark contrast to the dramatic amplification of Clone #14. Using the technique of the present invention, we observed significant binding and amplification by Pax3 of the Msx2 promoter after only two rounds of In vitro PORE, and of the TRP-1 promoter after three rounds (FIG. 3). As expected, Clone #14 likewise shows amplification after two rounds of binding by GST-FKHR (FIG. 4). In contrast, neither GST alone nor Clone #16, which does not contain the FKHR DNA recognition sequence, demonstrated any significant binding or amplification after only two rounds, confirming the specificity of the technique.

### EXAMPLE 6

The In Vitro PORE Genomic Screen

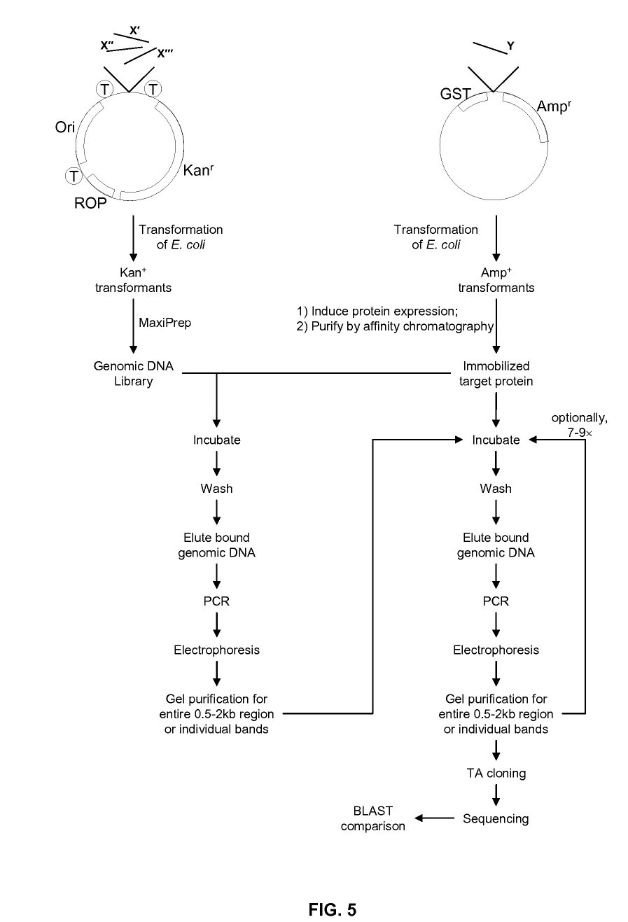

100 ng of the mouse genomic DNA library prepared as described above is used in the initial round of binding and selection. The genomic screen is performed as described above for the positive controls, except that different epitope-tagged target proteins may be substituted for GST-tagged Pax3 and GST-tagged FKHR. As shown in FIG. 5, the following additional alterations may also be made: 1) in the early rounds of binding and amplification, the portion of the gel corresponding to fragments of sizes 0.5-2.0 kb is excised and gel extracted, as described above, and used for subsequent rounds of binding and selection; 2) upon the appearance of individual bands in later rounds of binding and amplification, these individual bands are extracted and bound to the protein independently for subsequent rounds of binding and amplification; 3) the binding and amplification steps are performed for seven to nine rounds; 4) the resulting amplified fragments are TA-cloned into pCR®II PCR cloning vector, and sequenced. The presence of the known DNA-binding sequences of Pax3 and FKHR is identified in this manner, and the identity of the sequence is determined by BLAST analysis.

### EXAMPLE 7

Hybridization Assay

Genomic DNA of interest derived from the methods and processes of the present invention can be used as a probe in a DNA hybridization assay against DNA extracted from yeast colonies and organized on a solid support (e.g., a nitrocellulose filter). The stable genomic DNA library is cloned into host cells using standard techniques and plated at a density appropriate for yielding individual, separately identifiable colonies. Using standard techniques, colonies are lifted from the solid media, permeabilized, and incubated with labeled DNA probes. By identifying a yeast colony to which the DNA of interest hybridizes, one immediately has identified a yeast strain containing a molecule which interacts with the protein of interest encoded by the DNA of interest. The regulatory element that interacts with the protein of interest can then be cloned from a yeast cell derived from a hybridization positive colony.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A method for identifying genomic DNA ligands of a target protein from a genomic DNA library, the method comprising:
a) providing a genomic DNA library, wherein the library is comprised of genomic DNA fragments cloned into a plasmid vector;
b) contacting the genomic DNA library with the target protein, wherein genomic DNA fragments cloned into a plasmid vector having a higher affinity for the target protein relative to the genomic DNA library may be partitioned from the remainder of the genomic DNA library;
c) partitioning the higher-affinity genomic DNA fragments cloned into a plasmid vector from the remainder of the genomic DNA library; and
d) amplifying the higher-affinity genomic DNA fragments cloned into a plasmid vector, in vitro, to yield a genomic DNA ligand-enriched mixture of genomic DNA fragments cloned into a plasmid vector, whereby genomic DNA ligands that bind the target protein may be identified.

2. The method of claim 1, wherein the genomic DNA library is a stable genomic DNA library.

3. The method of claim 2, further comprising the step:
e) repeating steps b) through d) using the genomic DNA ligand-enriched mixture of each successive repeat as many times as required to yield a desired level of genomic DNA ligand enrichment, whereby genomic DNA ligands that bind the target protein may be identified.

4. The method of claim 3, wherein the target protein is a fusion protein comprising:
a) a known or putative DNA-binding protein; and
b) an epitope tag selected from the group consisting of GST tag, HA tag, Myc tag, FLAG tag, and His tag; and
the method further comprising immobilizing the target protein on a solid support.

5. The method of claim 4, wherein the plasmid vector is comprised of a blunt cloning site, a marker gene, a ROP gene, and at least two terminator sequences, wherein the at least two terminator sequences flank the blunt cloning site, and wherein the genomic DNA fragments cloned into the plasmid vector are cloned into the blunt cloning site.

6. The method of claim 4, wherein the plasmid vector is pSMART-LC-Kan.


SEQUENCE LISTING (8 sequences)

SEQ ID NO: 1 - DNA, 7458 bp, artificial
  circular plasmid DNA
gaattccccggatccacgcgtgagctcccgggtcgacgcggccgcgcggggaattcccggggagctcacgcgttcgcgaatcgatccgcggtctagaaattcctggcattatcacataatgaattatacattatataaagtaatgtgatttcttcgaagaatatactaaaaaatgagcaggcaagataaacgaaggcaaagatgacagagcagaaagccctagtaaagcgtattacaaatgaaaccaagattcagattgcgatctctttaaagggtggtcccctagcgatagagcactcgatcttcccagaaaaagaggcagaagcagtagcagaacaggccacacaatcgcaagtgattaacgtccacacaggtatagggtttctggaccatatgatacatgctctggccaagcattccggctggtcgctaatcgttgagtgcattggtgacttacacatagacgaccatcacaccactgaagactgcgggattgctctcggtcaagcttttaaagaggccctactggcgcgtggagtaaaaaggtttggatcaggatttgcgcctttggatgaggcactttccagagcggtggtagatctttcgaacaggccgtacgcagttgtcgaacttggtttgcaaagggagaaagtaggagatctctcttgcgagatgatcccgcattttcttgaaagctttgcagaggctagcagaattaccctccacgttgattgtctgcgaggcaagaatgatcatcaccgtagtgagagtgcgttcaaggctcttgcggttgccataagagaagccacctcgcccaatggtaccaacgatgttccctccaccaaaggtgttcttatgtagtgacaccgattatttaaagctgcagcatacgatatatatacatgtgtatatatgtatacctatgaatgtcagtaagtatgtatacgaacagtatgatactgaagatgacaaggtaatgcatcattctatacgtgtcattctgaacgaggcgcgctttccttttttctttttgctttttctttttttttctcttgaactcgagaaaaaaaatataaaagagatggaggaacgggaaaaagttagttgtggtgataggtggcaagtggtattccgtaagaacaacaagaaaagcatttcatattatggctgaactgagcgaacaagtgcaaaatttaagcatcaacgacaacaacgagaatggttatgttcctcctcacttaagaggaaaaccaagaagtgccagaaataacatgagcaactacaataacaacaacggcggctacaacggtggccgtggcggtggcagcttctttagcaacaaccgtcgtggtggttacggcaacggtggtttcttcggtggaaacaacggtggcagcagatctaacggccgttctggtggtagatggatcgatggcaaacatgtcccagctccaagaaacgaaaaggccgagatcgccatatttggtgtccccgaggatctgccaattctctagatatcgctcaatactgaccatttaaatcatacctgacctccatagcagaaagtcaaaagcctccgaccggaggcttttgacttgatcggcacgtaagaggttccaactttcaccataatgaaataagatcactaccgggcgtattttttgagttatcgagattttcaggagctaaggaagctaaaatgagccatattcaacgggaaacgtcttgctcgaggccgcgattaaattccaacatggatgctgatttatatgggtataaatgggctcgcgataatgtcgggcaatcaggtgcgacaatctatcgattgtatgggaagcccgatgcgccagagttgtttctgaaacatggcaaaggtagcgttgccaatgatgttacagatgagatggtcaggctaaactggctgacggaatttatgcctcttccgaccatcaagcattttatccgtactcctgatgatgcatggttactcaccactgcgatcccagggaaaacagcattccaggtattagaagaatatcctgattcaggtgaaaatattgttgatgcgctggcagtgttcctgcgccggttgcattcgattcctgtttgtaattgtccttttaacggcgatcgcgtatttcgtctcgctcaggcgcaatcacgaatgaataacggtttggttggtgcgagtgattttgatgacgagcgtaatggctggcctgttgaacaagtctggaaagaaatgcataagcttttgccattctcaccggattcagtcgtcactcatggtgatttctcacttgataaccttatttttgacgaggggaaattaataggttgtattgatgttggacgagtcggaatcgcagaccgataccaggatcttgccatcctatggaactgcctcggtgagttttctccttcattacagaaacggctttttcaaaaatatggtattgataatcctgatatgaataaattgcagtttcacttgatgctcgatgagtttttctaaatgaccaaacaggaaaaaaccgcccttaacatggcccgctttatcagaagccagacattaacgcttctggagaaactcaacgagctggacgcggatgaacaggcagacatctgtgaatcgcttcacgaccacgctgatgagctttaccgcagctgcctcgcgcgtttcggtgatgacggtgaaaacctctgatgagggccctggaattaattccacatgttaaaatagtgaaggagcatgttcggcacacagtggaccgaacgtggggtaagtgcactagggtccggttaaacggatctcgcattgatgaggcaacgctaattatcaacatatagattgttatctatctgcatgaacacgaaatctttacttgacgacttgaggctgatggtgtttatgcaaagaaaccactgtgtttaatatgtgtcactgtttgatattactgtcagcgtagaagataatagtaaaagcggttaataagtgtatttgagataagtgtgataaagtttttacagcgaaaagacgataaatacaagaaaatgattacgaggatacggagagaggtatgtacatgtgtatttatatactaagctgccggcggttgtttgcaagaccgagaaaaggctagcaagaatcgggtcattgtagcgtatgcgcctgtgaacattctcttcaacaagtttgattccattgcggtgaaatggtaaaagtcaaccccctgcgatgtatattttcctgtacaatcaatcaaaaagccaaatgatttagcattatctttacatcttgttattttacagattttatgtttagatcttttatgcttgcttttcaaaaggcctgcaggcaagtgcacaaacaatacttaaataaatactactcagtaataacctatttcttagcatttttgacgaaatttgctattttgttagagtcttttacaccatttgtctcccacctccgcttacatcaacaccaataacgccatttaatctaagcgcatcaccaacattttctggcgtcagtccaccagctaacataaaatgtaagctttcggggctctcttgccttccaacccagtcagaaatcgagttccaatccaaaagttcacctgtcccacctgcttctgaatcaaacaagggaataaacgaatgaggtttctgtgaagctgcactgagtagtatgttgcagtcttttggaaatacgagtcttttaataactggcaaaccgaggaactcttggtattcttgccacgactcatctccatgcagttggacgatatcaatgccgtaatcattgaccagagccaaaacatcctccttaggttgattacgaaacacgccaaccaagtatttcggagtgcctgaactatttttatatgcttttacaagacttgaaattttccttgcaataaccgggtcaattgttctctttctattgggcacacatataatacccagcaagtcagcatcggaatctagagcacattctgcggcctctgtgctctgcaagccgcaaactttcaccaatggaccagaactacctgtgaaattaataacagacatactccaagctgcctttgtgtgcttaatcacgtatactcacgtgctcaatagtcaccaatgccctccctcttggccctctccttttcttttttcgaccgaattaattccatggcagacatctgtgaatcgcttcacgaccacgctgatgagctttaccgctgggccattctcatgaagaatatcttgaatttattgtcatattactagttggtgtggaagtcctaatatcggtgatcaatatagtggttgacatgctggctagtcaacattgagccttttgatcatgcaaatatattacggtattttacaatcaaatatcaaacttaactattgactttataacttatttaggtggtaacattcttataaaaaagaaaaaaattactgcaaaacagtactagcttttaacttgtatcctaggttatctatgctgtctcaccatagagaatattacctatttcagaatgtatgtccatgattcgccgggtaaatacatataatacacaaatctggcttaataaagtctataatatatctcataaagaagtgctaaattggctagtgctatatatttttaagaaaatttcttttgactaagtccatatcgactttgtaaaagttcacattagcatacatatattacacgagccagaaatagtaacttttgcctaaatcacaaattgcaaaatttaattgcttgcaaaaggtcacatgcttataatcaacttttttaaaaatttaaaatacttttttattttttatttttaaacataaatgaaataatttatttattgtttatgattaccgaaacataaaacctgctcaagaaaaagaaactgttttgtccttggaaaaaaagcactacctaggagcggccaaaatgccgaggctttcatagcttaaactctttacagaaaataggcattatagatcagttcgagttttcttattcttccttccggttttatcgtcacagttttacagtaaataagtatcacctcttagagttaacctatactaaaatttatgccagttaactatgagataagcaagtatcatctcatttcattacctgaagtcgagtaaacagaaaatccaattgttgatgaacctcaatgacttagaactatctatcggcagatcatataaagaggatttaggtacctagaggactgtacctggagtatatatatatatatatatatattatctcaactatagtccatagaggtttctttcttgaggccttaaactgctaaagaatgatattggtggaatgcaagcaccaagcgctcttcttgcgtgactgttcatatacttcaaaccaagaatgtaactggcattgacccatccaaaaccttcagtagctgcccctttaaagtcagcaccttgattaccgtattctgcttcaacacgatgaggatctgttcctcttgtgacatcatatttttcaaccacaataccattataatcgacaaaagcctttgtcatcatgaaaagccatctataagctagcctattcgttacagttaaataaccataagaacggaggccttcccaagcaagaatttgatggggtgcccaaccaaatggatagtcccattgtctaattggtctcgaaatagaaattgggcctcgagaacgctccgtacatgcagctaaacctccaagcatctctaacttgggtagtgctttctccaccattttctgtgcttgctccttcgtggcaagtccagcccataatgcccagaatgtagttgcggattcgtatgacgttctgtgcttgatttttgtgttgtagtcaaagaaaaggtccggttaaacggatctcgcattgatgaggcaacgctaattatcaacatatagattgttatctatctgcatgaacacgaaatctttacttgacgacttgaggctgatggtgtttatgcaaagaaaccactgtgtttaatatgtgtcactgtttgatattactgtcagcgtagaagataatagtaaaagcggttaataagtgtatttgagataagtgtgataaagtttttacagcgaaaagacgataaatacaagaaaatgattacgaggatacggagagaggtatgtacatgtgtatttatatactaagctgccggcggttgtttgcaagaccgagaaaaggctagcaagaatcgggtcattgtagcgtatgcgcctgtgaacattctcttcaacaagtttgattccattgcggtgaaatggtaaaagtcaaccccctgcgatgtatattttcctgtacaatcaatcaaaaagccaaatgatttagcattatctttacatcttgttattttacagattttatgtttagatcttttatgcttgcttttcaaaaggcctgcaggcaagtgcacaaacaatacttaaataaatactactcagtaataacctatttcttagcatttttgacgaaatttgctattttgttagagtcttttacaccatttgtctccacacctccgcttacatcaacaccaataacgccatttaatctaagcgcatcaccaacattttctggcgtcagtccaccagctaacataaaatgttgcctcgcgcgtttcggtgatgacggtgaaaacctttgacacatgggcccaaatgtaatcacctggctcaccttcgggtgggcctttctgcgttgctggcgtttttccataggctccgcccccctgacgagcatcacaaaaatcgatgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaagaacagtatttggtatctgcgctctgctgaagccagttacctcggaaaaagagttggtagctcttgatccggcaaacaaaccaccgctggtagcggtggtttttttgtttgcaagcagcagattacgcgcagaaaaaaaggatctcaagaagatcctttgattttctaccgaagaaaggcccacccgtgaaggtgagccagtgagttgattgcagtccagttacgctggagtctgaggctcgtcctgaatgatatcaagctt

SEQ ID NO: 2 - DNA, 21 bp, Artificial
  oligonucleotide primer
cagtccagttacgctggagtc

SEQ ID NO: 3 - DNA, 39 bp, Artificial
  oligonucleotide primer
cgggatccgatatcaagcttttaccactgtgccttctcc

SEQ ID NO: 4 - DNA, 35 bp, Artificial
  oligonucleotide primer
cgacgcgtgatatcagctgttaattgcccgaagag

SEQ ID NO: 5 - DNA, 42 bp, Artificial
  oligonucleotide primer
cgggatccgatatctctacctaaattccctgctgaggagctc

SEQ ID NO: 6 - DNA, 38 bp, Artificial
  oligonucleotide primer
cgacgcgtgatatctaaccgtgaagcgttgagcacaga

SEQ ID NO: 7 - DNA, 33 bp, Artificial
  oligonucleotide primer
cgtgaaggtgagccagtgagttgattgcagtcc

SEQ ID NO: 8 - DNA, 31 bp, Artificial
  oligonucleotide primer
cgtgccgatcaagtcaaaagcctccggtcgg